(19) United States
(12) Patent Application Publication
(10) Pub. No.: US 2019/0005565 A1
(43) Pub. Date: Jan. 3, 2019

(54) METHOD AND SYSTEM FOR STOCK-BASED VEHICLE NAVIGATION

(71) Applicant: Faraday&Future Inc., Gardena, CA (US)

(72) Inventors: YongGe Hu, San Jose, CA (US); Carlos John Rosario, San Jose, CA (US)

(21) Appl. No.: 15/656,325

(22) Filed: Jul. 21, 2017

Related U.S. Application Data
(60) Provisional application No. 62/365,847, filed on Jul. 22, 2016.

(51) Int. Cl. G06Q 30/06; G01C 21/34; G06Q 10/08

(52) U.S. Cl. CPC G06Q 30/0633; G06Q 10/087; G01C 21/3484; G01C 21/3469

(57) ABSTRACT

A system for stock-based vehicle navigation is disclosed. The system may comprise a processing unit configured to receive first stock information, receive a user input, and determine a vehicle route based on the received first stock information and the received user input.

### CROSS-REFERENCE TO RELATED APPLICATIONS

This application claims the benefit of U.S. Provisional Application No. 62/365,847, filed Jul. 22, 2016, the entirety of which is hereby incorporated by reference.

### TECHNICAL FIELD

The present disclosure relates generally to methods and systems for vehicle navigation, and more particularly, to methods and systems for stock-based vehicle navigation.

### BACKGROUND

Buying groceries is essential to most households and can sometimes be frustrating. In order to most efficiently run the errands, one or more members of the household have to become the masterminds of planning: know what items to purchase, which stores usually have these items in stock, and how to navigate through these shopping stops. Since most of the steps are done manually, mistakes or lapses are common. For example, a certain essential item left out on the shopping list has to be purchased on a second trip to the store; a household member only discovers that a certain item is out of stock after arriving at the store and has to immediately plan a second trip; and a shopping trip gets stuck in terrible traffic, while frozen food melts down inside the vehicle.

### SUMMARY

One aspect of the present disclosure is directed to a system for stock-based vehicle navigation. The system may comprise a processing unit configured to receive first stock information, receive a user input, and determine a vehicle route based on the received first stock information and the received user input.

Another aspect of the present disclosure is directed to a vehicle. The vehicle may comprise a system for stock-based vehicle navigation. The system may comprise a processing unit configured to receive first stock information, receive a user input, and determine a vehicle route based on the received first stock information and the received user input.

Another aspect of the present disclosure is directed to a method for stock-based vehicle navigation. The method may comprise receiving first stock information, receiving a user input, and determining a vehicle route based on the received first stock information and the received user input.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this disclosure, illustrate several embodiments and, together with the description, serve to explain the disclosed principles.

FIG. 1 is a graphical representation illustrating a vehicle for stock-based vehicle navigation, consistent with exemplary embodiments of the present disclosure.

FIG. 2 is a block diagram illustrating a system for stock-based vehicle navigation, consistent with exemplary embodiments of the present disclosure.

FIG. 3 is a flowchart illustrating a method for stock-based vehicle navigation, consistent with exemplary embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention.

Current technologies are not adequate to help people run errands, such as buying groceries described in the background section. The disclosed systems and methods may mitigate or overcome one or more of the problems set forth above and/or other problems in the prior art.

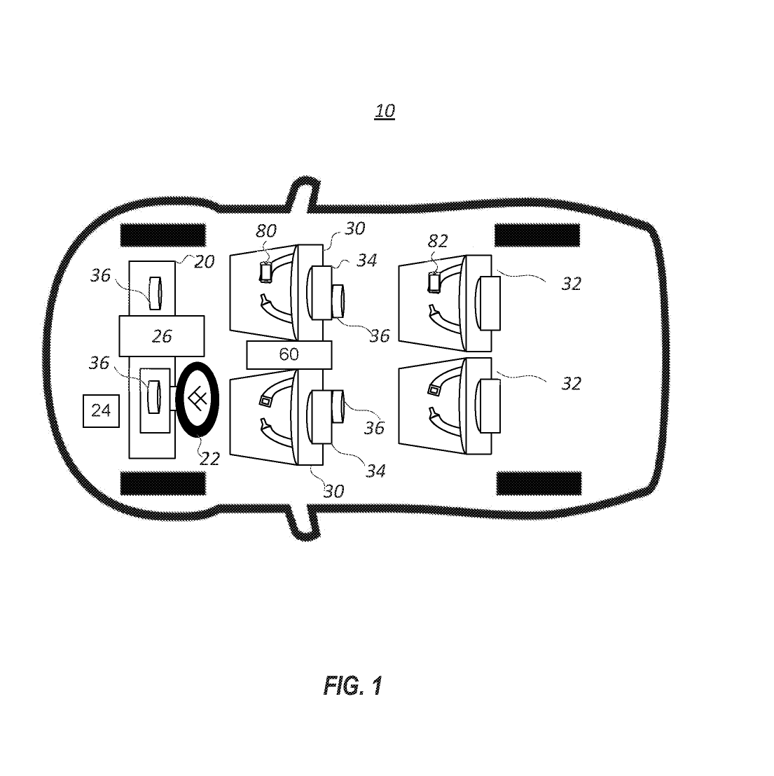

FIG. 1 is a graphical representation illustrating a vehicle 10 for stock-based vehicle navigation, consistent with exemplary embodiments of the present disclosure. Vehicle 10 may have any body style of an automobile, such as a sports car, a coupe, a sedan, a pick-up truck, a station wagon, a sports utility vehicle (SUV), a minivan, or a conversion van. Vehicle 10 may also embody other types of transportation, such as motorcycles, boats, buses, trains, and planes. Vehicle 10 may be an electric vehicle, a fuel cell vehicle, a hybrid vehicle, or a conventional internal combustion engine vehicle. Vehicle 10 may be configured to be operated by a driver occupying vehicle 10, remotely controlled, and/or autonomous. That is, the methods described herein can be performed by vehicle 10 with or without a driver.

As illustrated in FIG. 1, vehicle 10 may include a number of components, some of which may be optional. Vehicle 10 may have a dashboard 20 through which a steering wheel 22 and a user interface 26 may project. In one example of an autonomous vehicle, vehicle 10 may not include steering wheel 22. Vehicle 10 may also have one or more front seats 30 and one or more back seats 32 configured to accommodate occupants. Vehicle 10 may also include a temperature-dependent storing unit 60 disposed between front seats 30 or at another location of the vehicle, e.g., between or behind back seats 32. Temperature-dependent storing unit 60 may have a determined shape or may be inflatable or expandable. Vehicle 10 may further include one or more sensors 36 disposed at various locations of the vehicle and configured to detect and recognize occupants and/or perform other functions as described below. Vehicle 10 may also include a detector and GPS unit 24 disposed in front of steering wheel 22, on the top of the vehicle, or at other locations to detect objects, receive signals (e.g., GPS signal), and/or transmit data. Detector and GPS unit 24 may determine in real time the location of vehicle 10 and/or information of the surrounding environment, such as street signs, lane patterns, road marks, road conditions, environment conditions, weather conditions, and traffic conditions. The detector may include an onboard camera.

The positions of the various components of vehicle 10 in FIG. 1 are merely illustrative and are not limited as shown in the figure. For example, sensor 36 may include an infrared sensor disposed on a door next to an occupant, or a weight sensor embedded in a seat; detector and GPS unit 24 may be disposed at another position in the vehicle; and user interface 26 may be installed in front of each vehicle occupant.

In some embodiments, user interface 26 may be configured to receive inputs from users or devices and transmit data. For example, user interface 26 may have a display including an LCD, an LED, a plasma display, or any other type of display, and provide a graphical user interface (GUI) presented on the display for user input and data display. User interface 26 may further include speakers or other voice playing devices. User interface 26 may further include input devices, such as a touchscreen, a keyboard, a mouse, a microphone, and/or a tracker ball, to receive a user input. User interface 26 may also connect to a network to remotely receive instructions or user inputs. Thus, the input may be directly entered by a current occupant, captured by interface 26, or received by interface 26 over the network. User interface 26 may further include a housing having grooves containing the input devices. User interface 26 may be configured to provide internet access, cell phone access, and/or in-vehicle network access, such as Bluetooth™, CAN bus, or any other vehicle bus architecture protocol that may be used to access features or settings within vehicle 10. User interface 26 may be further configured to display or broadcast other media, such as images, videos, and maps.

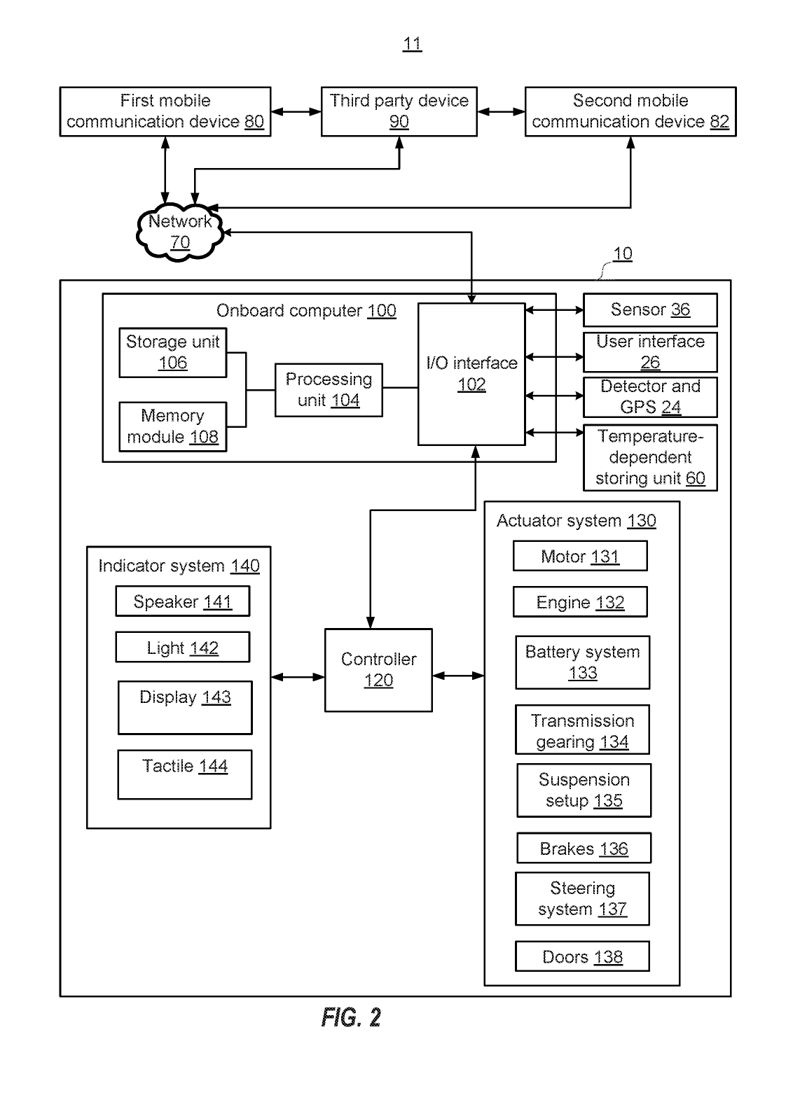

User interface 26 may also be configured to receive user-defined settings. For example, user interface 26 may be configured to receive occupant profiles including, for example, an age, a gender, a driving license status, an advanced driver assistance systems (ADAS) license status, an individual driving habit, a frequent destination, a store reward program membership, a frequently purchased item, favorite food, and etc. In some embodiments, user interface 26 may include a touch-sensitive surface configured to receive biometric data (e.g., detect a fingerprint of an occupant). The touch-sensitive surface may be configured to detect the ridges and furrows of a fingerprint based on a change in capacitance and generate a signal based on the detected fingerprint, which may be processed by an onboard computer described below with reference to FIG. 2. The onboard computer may be configured to compare the signal with stored data to determine whether the fingerprint matches recognized occupants. The onboard computer may also be able to connect to the Internet, obtain data from the Internet, and compare the signal with obtained data to identify the occupants. User interface 26 may be configured to include biometric data into a signal, such that the onboard computer may be configured to identify the person generating an input. User interface 26 may also compare a received voice input with stored voices to identify the person generating the input. Furthermore, user interface 26 may be configured to store data history accessed by the identified person.

In some embodiments, temperature-dependent storing unit 60 may be configured to control an interior of the storing unit above or below a temperature or within temperature range. For example, temperature-dependent storing unit 60 may be a vehicle-based fridge, cooler, freezer, warmer, or oven. Temperature-dependent storing unit 60 may include one or more sensors configured to monitor and/or predict a past, current, or future temperature, battery consumption, and storage space of the storing unit. Temperature-dependent storing unit 60 may also capture images of stored items, identify the items based on image recognition, and obtain item information such as the shelf life. Temperature-dependent storing unit 60 may transmit the above information to processing unit 104.

In some embodiments, sensor 36 may include one or sensors, such as a camera, a microphone sound detection sensor, an infrared sensor, a weight sensor, a radar, an ultrasonic, a LIDAR sensor, or a wireless sensor. Sensor 36 may be configured to generate a signal to be processed to detect and/or recognize occupants of vehicle 10. In one example, sensor 36 may obtain identifications from occupants' cell phones. In another example, a camera 36 may be positioned on the back of a headrest 34 of a front seat 30 to capture images of an occupant in a back seat 32. In some embodiments, visually captured videos or images of the interior of vehicle 10 by camera 36 may be used in conjunction with an image recognition software, such that the software may distinguish a person from inanimate objects, and may recognize the person based on physical appearances or traits. The image recognition software may include a facial recognition software configured to match a captured occupant with stored profiles to identify the occupant. In some embodiments, more than one sensor may be used in conjunction to detect and/or recognize the occupant(s). For example, sensor 36 may include a camera and a microphone, and captured images and voices may both work as filters to identify the occupant(s) based on the stored profiles.

In some embodiments, sensor 36 may include one or more electrophysiological sensors for encephalography-based autonomous driving. For example, a fixed sensor 36 may detect electrical activities of brains of the occupant(s) and convert the electrical activities to signals, such that the onboard computer can control the vehicle based on the signals. Sensor 36 may also be detachable and head-mountable, and may detect the electrical activities when worn by the occupant(s).

In some embodiments, sensor 36 may include one or more sensors configured to monitor a storage space of vehicle 36. For example, sensor 36 may include a trunk space sensor configured to monitor how much of the trunk space is occupied and determine how much can be used for storing additional items. For another example, sensor 36 may include a seat sensor configured to, together with processing unit 104, determine if a seat is or will be occupied, and therefore determine a seat space for storing items.

Vehicle 10 may be in communication with a plurality of mobile communication devices 80, 82. Mobile communication devices 80, 82 may include a number of different structures. For example, mobile communication devices 80, 82 may include a smart phone, a tablet, a personal computer, a wearable device, such as a smart watch or Google Glass™, and/or complimentary components. Mobile communication devices 80, 82 may be configured to connect to a network, such as a nationwide cellular network, a local wireless network (e.g., Bluetooth™ or WiFi), and/or a wired network. Mobile communication devices 80, 82 may also be configured to access apps and websites of third parties, such as iTunes™, Pandora™, Google™, Facebook™, and Yelp™.

In some embodiments, mobile communication devices 80, 82 may be carried by or associated with one or more occupants in vehicle 10. For example, vehicle 10 may be configured to determine the presence of specific people based on a digital signature or other identification information from mobile communication devices 80, 82. For instance, an onboard computer may be configured to relate the digital signature to stored profile data including the person's name and the person's relationship with vehicle 10. The digital signature of mobile communication devices 80, 82 may include a determinative emitted radio frequency (RF) or a global positioning system (GPS) tag. Mobile communication devices 80, 82 may be configured to automatically connect to or be detected by vehicle 10 through local network 70, e.g., Bluetooth™ or WiFi, when positioned within a proximity (e.g., within vehicle 10).

FIG. 2 is a block diagram illustrating a system 11 for stock-based vehicle navigation, consistent with exemplary embodiments of the present disclosure. System 11 may include a number of components, some of which may be optional. As illustrated in FIG. 2, system 11 may include vehicle 10, as well as other external devices connected to vehicle 10 through network 70. The external devices may include mobile communication devices 80, 82, and third party device 90. Vehicle 10 may include a specialized onboard computer 100, a controller 120, an actuator system 130, an indicator system 140, a sensor 36, a user interface 26, a detector and GPS unit 24, and a temperature-dependent storing unit 60. Onboard computer 100, actuator system 130, and indicator system 140 may all connect to controller 120. Sensor 36, user interface 26, detector and GPS unit 24, and temperature-dependent storing unit 60 may all connect to onboard computer 100. Onboard computer 100 may comprise, among other things, an I/O interface 102, a processing unit 104, a storage unit 106, a memory module 108. The above units of system 11 may be configured to transfer data and send or receive instructions between or among each other. Storage unit 106 and memory module 108 may be non-transitory and computer-readable and store instructions that, when executed by processing unit 104, cause system 11 or vehicle 10 to perform the methods described in this disclosure. Onboard computer 100 may be specialized to perform the methods and steps described below.

I/O interface 102 may also be configured for two-way communication between onboard computer 100 and various components of system 11, such as user interface 26, detector and GPS 24, sensor 36, and the external devices. I/O interface 102 may send and receive operating signals to and from mobile communication devices 80, 82 and third party devices 90. I/O interface 102 may send and receive the data between each of the devices via communication cables, wireless networks, or other communication mediums. For example, mobile communication devices 80, 82 and third party devices 90 may be configured to send and receive signals to I/O interface 102 via a network 70. Network 70 may be any type of wired or wireless network that may facilitate transmitting and receiving data. For example, network 70 may be a nationwide cellular network, a local wireless network (e.g., Bluetooth™ or WiFi), and/or a wired network.

Third party devices 90 may include smart phones, personal computers, laptops, pads, servers, and/or processors of third parties that provide access to contents and/or data (e.g., maps, traffic, store locations, weather, instruction, command, user input). Third party devices 90 may be accessible to the users through mobile communication devices 80, 82 or directly accessible by onboard computer 100, via I/O interface 102, according to respective authorizations of the user. For example, users may allow onboard computer 100 to receive third party contents by configuring settings of accounts with third party devices 90 or settings of mobile communication devices 80, 82.

In some embodiments, a person may use a third party device 90 to transmit information to vehicle 10. The transmit information may include an instruction to purchase a certain item. For example, a mother drives vehicle 10 to a grocery store, while her son suddenly craves for an ice-cream. Her son may use his cellphone to send an ice-cream request to vehicle 10, which may be displayed on user interface 26 and be incorporated in vehicle route determination by processing unit 104.

In some embodiments, third party device 90 may transmit information to vehicle 10. Third party device 90 may be a smart appliance or device comprising a processor and/or one or more sensors, or a computer/server that collect the information from the one or more sensors. The process and sensors may be deployed at various locations such as households, supermarkets, server rooms, warehouses, and the like. The transmitted information may include information regarding a certain item and/or an instruction to purchase a certain item. For example, third party device 90 may include a smart fridge configured to monitor quantities and qualities of stored items, e.g., how many eggs are kept in the fridge and the freshness of the eggs (or any other stored item) according to their expiration date. The smart fridge may transmit to vehicle 10 an image of the remaining eggs or transmit a number of the remaining eggs determined based on an image recognition software, so that processing 104 can determine if an egg purchase is needed, for example based on a remaining egg number and an average egg consumption rate collected by the smart fridge. Alternatively, processing 104 may just present the remaining egg number or a projected date of finishing all the eggs on user interface 26, mobile communication devices 80, 82, or other third party devices 90, so a person can make a purchase decision. A projected date may be based on historical data associated with an amount of time to consume a stored item. For another example, third party device 90 may include a smart shampoo bottle configured to monitor brand information of the shampoo and a remaining shampoo volume. The smart shampoo bottle may transmit such information to vehicle 10. For yet another example, third party device 90 may include a supermarket server transmitting to vehicle 10 goods information such as stock volumes, sales prices, promotion activities, pictures, and videos of various products, produces, or goods. The products, produces, or goods may be in store or may be stored somewhere else, and can be ordered to ship to a destination by vehicle 10.

Processing unit 104 may be configured to receive signals and process the signals to determine a plurality of conditions of the operation of vehicle 10, for example, operations of sensor 36 and operations of indicator system 140 through controller 120. Processing unit 104 may also be configured to generate and transmit command signals, via I/O interface 102, in order to actuate the devices in communication.

In some embodiments, processing unit 104 may be configured to determine the presence of people within an area, such as occupants of vehicle 10. Processing unit 104 may be configured to determine the identity of the occupants through a variety of mechanisms. For example, processing unit 104 may be configured to determine the presence of specific people based on a digital signature from mobile communication devices 80, 82. For instance, processing unit 104 may be configured to relate the digital signature to stored data including the person's name and the person's relationship with vehicle 10. The digital signature of communication device 80 may include a determinative emitted radio frequency (RF), GPS, Bluetooth™ or WiFi unique identifier. Processing unit 104 may also be configured to determine the presence of people within vehicle 10 by GPS tracking software of mobile communication devices 80, 82. In some embodiments, vehicle 10 may be configured to detect mobile communication devices 80, 82 when mobile communication devices 80, 82 connect to local network 70 (e.g., Bluetooth™ or WiFi).

In some embodiments, processing unit 104 may also be configured to recognize occupants of vehicle 10 by receiving inputs with user interface 26. For example, user interface 26 may be configured to receive direct inputs of the identities of the occupants. User interface 26 may also be configured to receive biometric data (e.g., fingerprints) from occupants when manipulating user interface 26. Processing unit 104 may be further configured to recognize occupants by facial recognition software used in conjunction with sensor 36.

In some embodiments, processing unit 104 may be configured to access and collect sets of data related to the people within the area in a number of different manners. Processing unit 104 may be configured to store the sets of data in a database. In some embodiments, processing unit 104 may be configured to access sets of data stored on mobile communication devices 80, 82, such as apps, audio files, text messages, notes, messages, photos, and videos. Processing unit 104 may also be configured to access accounts associated with third party devices 90, by either accessing the data through mobile communication devices 80, 82 or directly accessing the data from third party devices 90. Processing unit 104 may be configured to receive data directly from occupants, for example, through access of user interface 26. For example, occupants may be able to directly input vehicle settings, such as a desired internal temperature. Processing unit 104 may also be configured to receive data from history of previous inputs of the occupant into user interface 26.

In some embodiments, processing unit 104 may be configured to extract data from the collected sets of data to determine the occupant's interests and store the extracted data in a database. For example, processing unit 104 may be configured to determine favorite restaurants or types of food through occupant search histories or Yelp™ reviews. Processing unit 104 may be configured to store data related to an occupant's previous destinations and purchase histories using vehicle 10. Processing unit 104 may further be configured to execute character recognition software to determine the contents of messages or posts of occupants on social media to recognize keywords related to interests. For another example, processing unit 104 may be configured to determine frequency grocery stores and/or purchased items through vehicle locations and/or occupant credit card usage history. Based on such information, processing unit 104 can determine the preferred stores to purchase certain items, the preferred frequency to restock certain items, and incorporate such information in vehicle navigation described below. Further, processing unit 104 can obtain the above information of any identified person. For example, similar information of a household member, who may not be present in vehicle 10, may also be stored and collected by vehicle 10 by manual identification.

Storage unit 106 and/or memory module 108 may be configured to store one or more computer programs that may be executed by onboard computer 100 to perform functions of system 11. For example, storage unit 106 and/or memory module 108 may be configured to store biometric data detection and processing software configured to determine the identity of people based on fingerprint(s), and store image recognition software configured to relate images to identities of people. Storage unit 106 and/or memory module 108 may be further configured to store data and/or look-up tables used by processing unit 104. For example, storage unit 106 and/or memory module 108 may be configured to include data related to individualized profiles of people related to vehicle 10. In some embodiments, storage unit 106 and/or memory module 108 may store the stored data and/or the database described in this disclosure.

In some embodiments, processing unit 104 may also receive data from one or more sensors of temperature-dependent storing unit 60, store the data in storage unit 106 and/or memory module 108, and display some of the data on user interface 26.

Vehicle 10 can also include a controller 120 connected to the onboard computer 100 and capable of controlling one or more aspects of vehicle operation, such as performing autonomous parking or driving operations using instructions from the on-board computer 100.

In some examples, the controller 120 is connected to one or more actuator systems 130 in the vehicle and one or more indicator systems 140 in the vehicle. The one or more actuator systems 130 can include, but are not limited to, a motor 131 or engine 132, battery system 133, transmission gearing 134, suspension setup 135, brakes 136, steering system 137, and door system 138. Temperature-dependent storing unit 60 may communicate with battery system 133 to obtain battery information, such as a remaining operation time of the storing unit according to the power level of battery system 133. Steering system 137 may include steering wheel 22 described above with reference to FIG. 1. The onboard computer 100 can control, via controller 120, one or more of these actuator systems 130 during vehicle operation; for example, to open or close one or more of the doors of the vehicle using the door actuator system 138, to control the vehicle during autonomous driving or parking operations, using the motor 131 or engine 132, battery system 133, transmission gearing 134, suspension setup 135, brakes 136 and/or steering system 137, etc. The one or more indicator systems 140 can include, but are not limited to, one or more speakers 141 in the vehicle (e.g., as part of an entertainment system in the vehicle or part of user interface 26), one or more lights 142 in the vehicle, one or more displays 143 in the vehicle (e.g., as part of a control or entertainment system in the vehicle) and one or more tactile actuators 144 in the vehicle (e.g., as part of a steering wheel or seat in the vehicle). Onboard computer 100 can control, via controller 120, one or more of these indicator systems 140 to provide indications to a driver of the vehicle of one or more characteristics of the vehicle's surroundings. The characteristics may be determined by sensor 36.

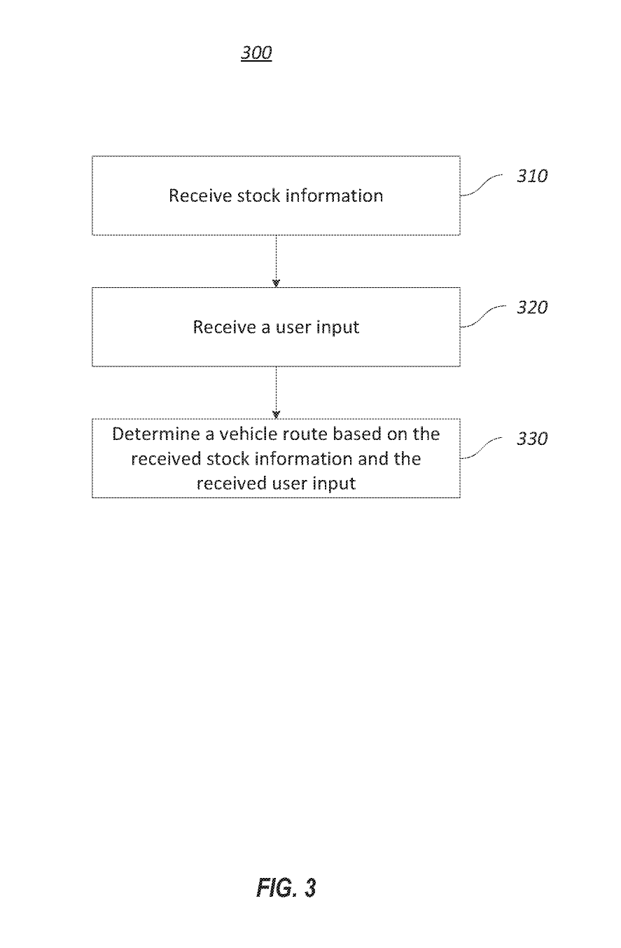

FIG. 3 is a flowchart illustrating a method 300 for stock-based vehicle navigation, consistent with exemplary embodiments of the present disclosure. Method 300 may include a number of steps and sub-steps, some of which may be optional, e.g., step 320. The steps or sub-steps may also be rearranged in another order.

In Step 310, one or more components of system 11, e.g., processing unit 104, may receive stock information, from one or more devices such as mobile communication devices 80, 82 and third party device 90. The one or more devices may be deployed at various locations such as households, supermarkets, server rooms, warehouses, and the like. The stock information may include a past, a current, or a predicted future stock level of one or more items. The stock information may also include stock volumes, sales prices, promotion activities, pictures, and videos of the one or more items. The one or more items may be any kind of products, produces, or goods such as household groceries.

In some embodiments, processing unit 104 may receive the stock information from mobile communication device 80, 82, third party device 90, sensor 36, or user interface 26. For example, a person may use third party device 90 to order a watermelon purchase by vehicle 10.

In some embodiments, vehicle 10 may receive the stock information from a smart appliance. The information may be synced in real time, transmitted at predetermined time intervals, or transmitted upon request. The information may comprise an identity, a quantity, a quality, a consumption or usage rate, a picture, and/or a video of one or more items stored in the smart appliance. For example, processing unit 104 may receive a volume and a consumption rate of stored milk from a smart fridge, which comprises a smart build-in milk carton monitoring the milk volume and a consumption rate. Processing unit 104 may also receive a shelf life of the milk and a picture of the milk. Processing unit 104 may display the above received information from the smart fridge on user interface 26. Processing unit 104 may further determine, for example, a remaining time (e.g., days) of milk supply based on the remaining amount and the consumption rate, and also display such information on user interface 26. As described, vehicle 10 may obtain various information of stored items in the smart fridge. Similarly, vehicle 10 may obtain such information of other items from various smart devices or sensors, such as stored items in temperature-dependent storing unit 60, or shampoo from a smart shampoo bottle. Processing unit 104 may communicate with smart devices in one or more households and collect information respectively. Processing unit 104 may compile these items and information into any presentation format (e.g., visual, audio) and present on user interface 26.

In some embodiments, vehicle 10 may receive the stock information from a supermarket server or a supermarket smart sensor. The stock information may include any item offered for sale, which may be in store, stored somewhere else, or may be shipped to a destination. For example, vehicle 10 may receive stock information of live lobsters from supermarket ABC's server or a smart lobster tank in the supermarket. The stock information may include a number of live lobsters in store, a number of lobsters that can be shipped to store within a predetermined number of days, how long ago the lobsters were harvested, the weight of each lobster, a price of the lobsters, and/or a real-time picture or video of the lobsters.

In some embodiments, the received stock information may be associated with one or more people, and/or vehicle 10 may associate the stock information with one or more people. The received stock information may comprise the information of the association relationship (e.g., the associated one or more people). The one or more people may or may not be inside vehicle 10. For example, the smart fridge may use an image recognition software to recognize a person fetching any item from the fridge to determine the person as a consumer of the item, establishing as association relationship between the person and the item. For another example, the association relationship may be manually entered by a person via mobile communication devices 80, 82, third party device 90, and/or user interface 26. For yet another example, a person may have used third party device 90 to order item purchases by vehicle 10, and vehicle 10 may determine an association relationship between the item and the person and store such purchase history.

In some embodiments, vehicle 10 may detect a number of occupants in vehicle 10 and their identities, and determine one or more items associated with the occupants as the stock information. For example, sensor 36 may include a cellphone detection sensor that detect the occupants according to mobile communication devices 80, 82 connected to a local wireless network (e.g., Bluetooth™) of vehicle 10, and transmit the detected number to processing unit 104. For another example, user interface 26 may detect the occupants according to manual entry of data into vehicle 10, e.g., occupants selecting individual names through user interface 26, and transmit the detected number to processing unit 104. Processing unit 104 may also collect biometric data (e.g., fingerprint data) from the occupants through user interface 26. For another example, sensor 36 may include cameras that capture images of occupants, microphones that capture voices of occupants, and/or weight sensors that capture weights of objects on the vehicle seats. Based on the received data from these sensors, processing unit 104 may determine associated items of the occupants in vehicle 10.

In some embodiments, one or components of system 11 may determine each occupant's identity, by executing a software such as an image recognition software, a voice recognition software, or a weight recognition software, based on the received data from sensor 36 and/or user interface 26. For example, sensor 36 may detect a digital signature or other identification information from mobile communication devices that occupants carry, and processing unit 104 may determine the occupants' identifies based on the digital signatures. Processing unit 104 may access, collect, and update sets of data related to each occupant in vehicle 10. Processing unit 104 may determine whether the determined occupants have stored profiles. Processing unit 104 may also access sets of data stored on mobile communication device 80, 82 and third party devices 90 to update the stored profile(s). If an occupant does not have a stored profile, processing unit 104 may generate a profile based on the accessed data. Each profile may include information such as age, gender, driving license status, driving habit, frequent destination, favorite food, shopping habit, enrolled store reward program, and the associated item(s). For example, processing unit 104 may determine the interests of one or more (e.g., each) of the occupants of vehicle 10 according to their enrolled store reward programs. Processing unit 104 may determine each of the occupant's preferences, for example, in food. Processing unit 104 may thus use the items associated with each profile as a part of the stock information.

In Step 320, one or more components of system 11 may receive a user input. In some embodiments, processing unit 104 may receive the user input from someone operating mobile communication device 80, 82, or third party device 90. For example, a user may use first mobile communication device 80 to include a store destination for a grocery trip.

In some embodiments, processing unit 104 may receive the user input from a current occupant of vehicle 10 via sensor 36 and/or user interface 25. An occupant of vehicle 10 may input a store destination through user interface 26, such as directly entering an address of the store. An occupant of vehicle 10 may also input the destination through sensor 36, such as sending instructions through the electrophysiological sensors. In some embodiments, vehicle 10 may determine the store destination. For example, processing unit 104 may store data such as individual's frequent stores at storage unit 106 and/or memory module 108. After determining an occupant's identity and past operation histories, processing unit 104 may recommend a the occupant's frequent store destinations as the user input.

In some embodiments, the user input may be a command to generate a vehicle route for purchasing one or more items. The command may also include one or more parameters, options, or conditions regarding the vehicle route. For example, the user may determine the one or more items to purchase; the user may determine one or more stores to be included in the route; the user may determine a time to generate the route; the user may define an area for planning the route; or the user may not define any parameter and request an optimized route based on time and/or cost. The above user actions can also be performed by vehicle 10. For example, vehicle 10 can automatically determine all household members of one or more households and their associated items as described above with reference to FIG. 2, recommend the associated items to purchase, determine a route based on items to purchase, etc.

In some embodiments, the user input may include an urgency level. For example, the smart fridge may have a button to indicate an urgency level for certain items such as baby formula, diapers, or medicine. Vehicle 10 or mobile communication devices 80, 82 may receive such user input.

In Step 330, one or more components of system 11 may determine a vehicle route based on the received stock information and the received user input. One or more components of system 11, e.g., processing unit 104, may first determine one or more items to purchase and one or more candidate stores to purchase from, and determine the vehicle route based on the determined items and candidate stores.

In some embodiments, the items to purchase can be edited and determined in various manners and be subject to various conditions described below. For example, the items to purchase can be determined as described above with reference to Step 310 and Step 320. For another example, a user can edit the items to purchase via mobile communication devices 80, 82 and/or third party device 90. The items to purchase may have various priorities. The smart fridge or vehicle 10 may determine the priorities. For example, medicine may have the highest priority, daily essentials such as shampoo and milk may have a high priority according to user habits and stock levels, and non-essential items such as a decorative item may have a low priority. In some situations, for example, when the time or the storage space is limited, items to purchase may be determined according to the priority levels. The storage space may be monitored by sensor 36 and/or temperature-dependent storing unit 60 described above with reference to FIG. 2. For example, if the temperature-dependent storing unit 60 is a mini-fridge, it may determine a limit of frozen food to purchase according to a current storage space of the mini-fridge. The mini-fridge may also determine the limit of frozen food to purchase according to battery information as described above. For example, if vehicle 10 does not have enough battery supply and cannot be charged until vehicle 10 reaches home, the mini-fridge may determine zero or less purchase of frozen food.

In some embodiments, the one or more candidate stores to purchase from can be determined according to the user input described above, or can be automatically determined by processing unit 104. For example, a user may select one or more stores to purchase the items from. For another example, processing unit 104 may determine, according to information received from the supermarket server or sensor described above, one or more candidate stores that have the one or more purchase items in stock. For yet another example, processing unit 104 may record frequent stores and items purchased from these stores based on, for example, past location information of vehicle 10 and credit card spending histories at the stores; and determine the stores as regular places to purchase these item. One or more of the candidate stores may be included in the vehicle route determination.

In some embodiments, processing unit 104 may determine the vehicle route based on one or more conditions. The conditions may include, for example, optimizing time and/or cost. With respect to optimizing time, processing unit 104 may determine a route that requires the least total time to complete the purchase, including time spent at the store(s) and travel time. The time spent at any store can be estimated based on past trip histories and item purchases at the store. The travel time can be determined based on a time of the day, traffic condition, and routes. With respect to optimizing cost, processing unit 104 may determine a route that is most economical for the purchase. Processing unit 104 may determine the route based on conditions such as item prices, reward programs, promotions, and/or operation costs of vehicle 10 (e.g., gas cost, electricity cost, mileage cost). For example, vehicle 10 plans to leave from home, purchase items A, B, C, and D, and come back. Store X is only 5 miles away and has all four items selling at a high price. Store Y is 7 miles away and only has A and B selling at a low price. Store Z is 8 miles away and only has C and D selling at a low price. Provided that other conditions being equal, under a time-saving mode, vehicle 10 may determine a route to store X only; and under a cost-saving mode vehicle 10 may determine a route to stores Y and Z. In real practices, the conditions may be more complicated, and other conditions may be included in determining the vehicle route.

In some embodiments, processing unit 104 may receive map information from mobile communication devices 80,82, third party device 90, and/or detector and GPS 24, and store the map information at storage unit 106 and/or memory module 108. The map information may include weather information and/or traffic information. Upon determining the current position and the destination of vehicle 10, processing unit 104 may locate the current position and the destination (e.g. store destination) according to the map information, and determine one or more possible routes from the current position to the destination, consistent with the above-described conditions.

In some embodiments, one or more components of system 11 may determine other information, such as a Global Positioning System (GPS) signal, sign information, road mark information, weather information, route traffic information, lane traffic information, lane feature information, vehicle feature information, or environment information to use as a factor in determining the vehicle route, for example, to minimize the travel time. For example, detector and GPS 24 may include a GPS unit that communicates with space-level sensors (e.g., satellites), air-level sensors (e.g., balloon-carried sensors), and/or ground-level sensors (e.g., street cameras, transmission towers) to determine a current location of the vehicle. Detector and GPS 24 may store and use a high resolution map.

In some embodiments, vehicle 10 may be driverless and can perform the methods and steps disclosed herein without a driver. For example, processing unit 104 may control vehicle 10 to automatically drive to a store, obtain purchased items, and drive to another destination according to the determined vehicle route.

In some embodiments, third party device 90 may be a network of smart appliances such as smart fridges. The fridges may communicate with each other and vehicle 10 regarding information such as stored items and stock levels. The fridges may collectively determine purchase items and order vehicle 10 to purchase and deliver the items to one or more locations. Through the network of smart appliances, vehicle 10 can also automatically determine all household members of one or more households and their associated items, and vehicle 10 can determine an optimized route to purchase and restock all items that are in low stock. People may also interact or control vehicle 10 via the smart fridge, for example, through control panels on the fridges.

In some embodiments, the above-described systems and methods can be applied to competition vehicles, such as race cars and motorcycles. For example, the stores can be substituted by maintenance stops or check-in points, and the purchase item can be substituted by maintenance supplies. The systems and methods can be implemented to assist with racing by identifying a fastest route. Output generated by systems can be transmitted to third party device 90, e.g., a computer, for further analysis by a race crew.

In some embodiments, the above-described systems and methods can be applied to vehicles in a platoon. Vehicles traveling in a platoon may travel in a formation with small separations, and accelerate and brake together. Autonomous vehicles may join or leave the platoon formation automatically. Vehicle 10 may consider the presence of a platoon in the route determination, since a platoon may move at a higher-than-average speed and joining a platoon may be cost-effective.

Another aspect of the disclosure is directed to a non-transitory computer-readable medium storing instructions which, when executed, cause one or more processors to perform the method, as discussed above. The computer-readable medium may include volatile or non-volatile, magnetic, semiconductor, tape, optical, removable, non-removable, or other types of computer-readable storage medium or computer-readable storage devices. For example, the computer-readable medium may be the storage unit or the memory module having the computer instructions stored thereon, as disclosed. In some embodiments, the computer-readable medium may be a disc or a flash drive having the computer instructions stored thereon.

A person skilled in the art can further understand that, various exemplary logic blocks, modules, circuits, and algorithm steps described with reference to the disclosure herein may be implemented as specialized electronic hardware, computer software, or a combination of electronic hardware and computer software. For examples, the modules/units may be implemented by one or more processors to cause the one or more processors to become one or more special purpose processors to executing software instructions stored in the computer-readable storage medium to perform the specialized functions of the modules/units.

The flowcharts and block diagrams in the accompanying drawings show system architectures, functions, and operations of possible implementations of the system and method according to multiple embodiments of the present invention. In this regard, each block in the flowchart or block diagram may represent one module, one program segment, or a part of code, where the module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on the functions involved. Each block in the block diagram and/or flowchart, and a combination of blocks in the block diagram and/or flowchart, may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware for allowing specialized components to perform the functions described above. Furthermore, embodiments of the present disclosure may take the form of a computer program product embodied in one or more tangible and/or non-transitory computer-readable storage media containing computer-readable program codes. Common forms of non-transitory computer readable storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Embodiments of the present disclosure are described with reference to flow diagrams and/or block diagrams of methods, devices (systems), and computer program products according to embodiments of the present disclosure. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a computer, an embedded processor, or other programmable data processing devices to produce a special purpose machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer-readable memory that can direct a computer or other programmable data processing devices to function in a particular manner, such that the instructions stored in the computer-readable memory produce a manufactured product including an instruction means that implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions (which are executed on the computer or other programmable devices) provide steps for implementing the functions specified in one or more flows in the flow diagrams and/or one or more blocks in the block diagrams. In a typical configuration, a computer device includes one or more Central Processing Units (CPUs), an input/output interface, a network interface, and a memory. The memory may include forms of a volatile memory, a random access memory (RAM), and/or non-volatile memory and the like, such as a read-only memory (ROM) or a flash RAM in a computer-readable storage medium. The memory is an example of the computer-readable storage medium.

The computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The computer-readable medium includes non-volatile and volatile media, and removable and non-removable media, wherein information storage can be implemented with any method or technology. Information may be modules of computer-readable instructions, data structures and programs, or other data. Examples of a non-transitory computer-readable medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, a cache, a register, or any other non-transmission media that may be used to store information capable of being accessed by a computer device. The computer-readable storage medium is non-transitory, and does not include transitory media, such as modulated data signals and carrier waves.

The specification has described methods, apparatus, and systems for stock-based vehicle navigation. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with the disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A system for stock-based vehicle navigation, the system comprising a processing unit configured to:
receive first stock information;
receive a user input; and
determine a vehicle route based on the received first stock information and the received user input.

2. The system of claim 1, wherein the processing unit is configured to receive the first stock information from an appliance.

3. The system of claim 2, wherein the first stock information includes information on a storage space of the appliance.

4. The system of claim 1, wherein the first stock information includes a stock level of an item.

5. The system of claim 4, wherein the user input includes an order to purchase the item.

6. The system of claim 1, wherein the processing unit is further configured to:
determine one or more items to purchase based on the received first stock information and the received user input;
determine one or more candidate stores; and
determine the vehicle route based on the one or more items to purchase and the one or more candidate stores.

7. The system of claim 6, wherein the processing unit is further configured to:
obtain second stock information from one or more stores; and
match the second stock information with the one or more items to purchase to determine the one or more candidate stores from the one or more stores.

8. The system of claim 6, wherein the processing unit is further configured to determine the vehicle route based on at least one of a minimized time or a minimized cost.

9. The system of claim 6, wherein the processing unit is further configured to determine the vehicle route based on battery information of the system.

10. A vehicle comprising a system for stock-based vehicle navigation, the system comprising a processing unit configured to:
receive first stock information;
receive a user input; and
determine a vehicle route based on the received first stock information and the received user input.

11. The vehicle of claim 10, wherein the processing unit is configured to receive the first stock information from an appliance.

12. The vehicle of claim 11, wherein the first stock information includes information on a storage space of the appliance.

13. The vehicle of claim 10, wherein the first stock information includes a stock level of an item.

14. The vehicle of claim 13, wherein the user input includes an order to purchase the item.

15. The vehicle of claim 10, wherein the processing unit is further configured to:
determine one or more items to purchase based on the received first stock information and the received user input;
determine one or more candidate stores; and
determine the vehicle route based on the one or more items to purchase and the one or more candidate stores.

16. The vehicle of claim 15, wherein the processing unit is further configured to:
obtain second stock information from one or more stores; and
match the second stock information with the one or more items to purchase to determine the one or more candidate stores from the one or more stores.

17. The vehicle of claim 15, wherein the processing unit is further configured to determine the vehicle route based on at least one of a minimized time or a minimized cost.

18. The vehicle of claim 15, wherein the processing unit is further configured to determine the vehicle route based on battery information of the vehicle.

19. A method for stock-based vehicle navigation, the method comprising:
receiving first stock information;
receiving a user input; and
determining a vehicle route based on the received first stock information and the received user input.

20. The method of claim 19, wherein determining the vehicle route based on the received first stock information and the received user input comprises:
determining one or more items to purchase based on the received first stock information and the received user input;
determining one or more candidate stores; and
determine the vehicle route based on the one or more items to purchase and the one or more candidate stores.
